(19) United States
(12) Patent Application Publication
(10) Pub. No.: US 2021/0194741 A1
(43) Pub. Date: Jun. 24, 2021

(54) IMPROVED CHANNEL STATE INFORMATION REFERENCE SIGNAL GENERATION

(71) Applicants: Chenxi HAO, San Diego, CA (US); Chao WEI, San Diego, CA (US); Yu ZHANG, San Diego, CA (US); Liangming WU, San Diego, CA (US); Wanshi CHEN, San Diego, CA (US); QUALCOMM Incorporated, San Diego, CA (US)

(72) Inventors: Chenxi HAO, Beijing (CN); Chao WEI, Beijing (CN); Yu ZHANG, Beijing (CN); Liangming WU, Beijing (CN); Wanshi CHEN, San Diego, CA (US)

(21) Appl. No.: 16/756,184

(22) PCT Filed: Nov. 10, 2017
(86) PCT No.: PCT/CN2017/110387

§ 371 Date: Apr. 15, 2020

(51) Int. Cl. H04L 27/26; H04L 5/00; H04B 7/06

(52) U.S. Cl. CPC H04L 27/2613; H04B 7/0626; H04L 27/26025; H04L 5/0051

(57) ABSTRACT

Certain aspects of the present disclosure provide techniques for generating and using channel state information reference signals (CSI-RS). In some aspects, a method for generating a Channel State Information-Reference Signal may include: generating a pseudo-random base sequence based on at least a time parameter of the CSI-RS; modifying the pseudo-random base sequence based on at least a frequency parameter of the CSI-RS to form a modified pseudo-random sequence; generating the CSI-RS based on the modified pseudo-random sequence; and transmitting the CSI-RS to a user equipment.

### INTRODUCTION

Aspects of the present disclosure relate to wireless communications, and more particularly, to techniques for generating channel state information reference signals (CSI-RS).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations, each simultaneously supporting communication for multiple communication devices, otherwise known as user equipments (UEs). In LTE or LTE-A network, a set of one or more base stations may define an eNodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, gNodeB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL), as well as supporting beamforming, multiple-input multiple-output (MIMO) antenna technology, and carrier aggregation.

However, as the demand for mobile broadband access continues to increase, there exists a need for further improvements in NR technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between participants in a wireless network.

Certain aspects provide a method for wireless communication. In particular, a method for generating a Channel State Information-Reference Signal (CSI-RS) may include: generating a pseudo-random base sequence based on at least a time parameter; modifying the pseudo-random base sequence based on at least a frequency parameter to form a modified pseudo-random sequence; generating the CSI-RS using the modified pseudo-random sequence; and transmitting the CSI-RS to a user equipment.

In another aspect, a method for performing channel estimation using a Channel State Information-Reference Signal (CSI-RS) includes: generating a pseudo-random base sequence based on at least a time parameter of the CSI-RS; modifying the pseudo-random base sequence based on at least a frequency parameter of the CSI-RS to form a modified pseudo-random sequence; and performing channel estimation using the CSI-RS based on the modified pseudo-random sequence.

To the accomplishment of the foregoing and related ends, the one or more aspects comprise the features hereinafter fully described and particularly pointed out in the claims. The following description and the related drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed RAN, in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a DL-centric subframe, in accordance with certain aspects of the present disclosure.

FIG. 7 illustrates an example of an UL-centric subframe, in accordance with certain aspects of the present disclosure.

FIG. 8A depicts an example wireless communication system, in accordance with certain aspects of the present disclosure.

FIG. 8B depicts an example of resource element mappings for resource blocks, in accordance with certain aspects of the present disclosure.

FIG. 9 depicts further details of an example of a resource block, in accordance with certain aspects of the present disclosure.

FIG. 10A depicts an example of a method for generating channel state information reference signals (CSI-RS), in accordance with certain aspects of the present disclosure.

FIG. 10B depicts an example of a method for performing channel estimation using a channel state information reference signals (CSI-RS), in accordance with certain aspects of the present disclosure.

FIGS. 11A and 11B illustrate communications devices that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for generating and using channel state information reference signals (CSI-RS).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA. OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000. IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA). Ultra Mobile Broadband (UMB), IEEE 802.11 (Wi-Fi). IEEE 802.16 (WiMAX). IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS. LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New Radio (NR) may support various wireless communication services, such as: Enhanced Mobile Broadband (eMBB) targeting wide bandwidth (e.g. 80 MHz and beyond), millimeter wave (mmW) targeting high carrier frequency (e.g. 27 GHz and beyond), massive machine-type communication (mMTC) targeting non-backward compatible machine-type communication (MTC) techniques, and/or mission critical services targeting ultra-reliable low latency communications (URLLC). These services may include latency and reliability requirements. These services may also have different transmission time intervals (TTIs) to meet respective quality of service (QoS) requirements. In addition, these services may coexist in the same subframe. In LTE, the basic transmission time interval (TTI) or packet duration is 1 subframe of 1 ms, and a subframe may be further divided into two slots of 0.5 ms each. In NR, a subframe may still be 1 ms, but the basic TTI may be referred to as a slot. Further, in NR, a subframe may contain a variable number of slots (e.g., 1, 2, 4, 8, 16, . . . slots) depending on the tone spacing (e.g., 15, 30, 60, 120, 240, . . . kHz).

### Example Wireless Communications System

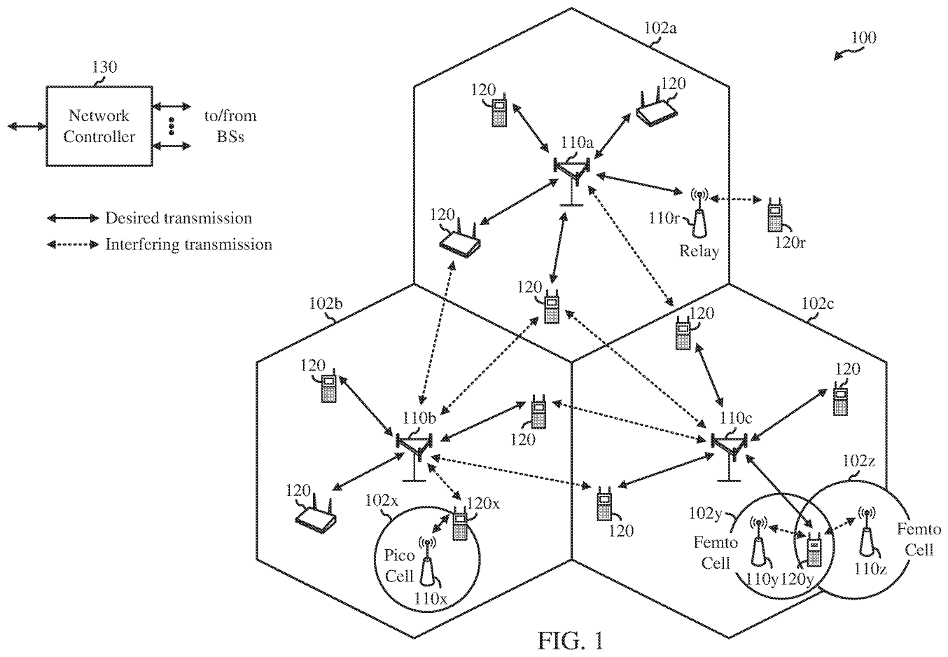

FIG. 1 illustrates an example wireless communication network 100 in which aspects of the present disclosure may be performed. For example, the wireless network may be a New Radio (NR) or 5G network.

As illustrated in FIG. 1, the wireless network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and gNB, Node B, 5G NB, AP, NR BS, NR BS, or TRP may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in the wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A base station (BS) may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

The wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 10a and the UE 120r. A relay station may also be referred to as a relay BS, a relay, etc.

The wireless network 100 may be a heterogeneous network that includes BSs of different types. e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices.

In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into sub-bands. For example, a sub-band may cover 1.08 MHz (i.e., 6 resource blocks), and there may be 1, 2, 4, 8, or 16 sub-bands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR.

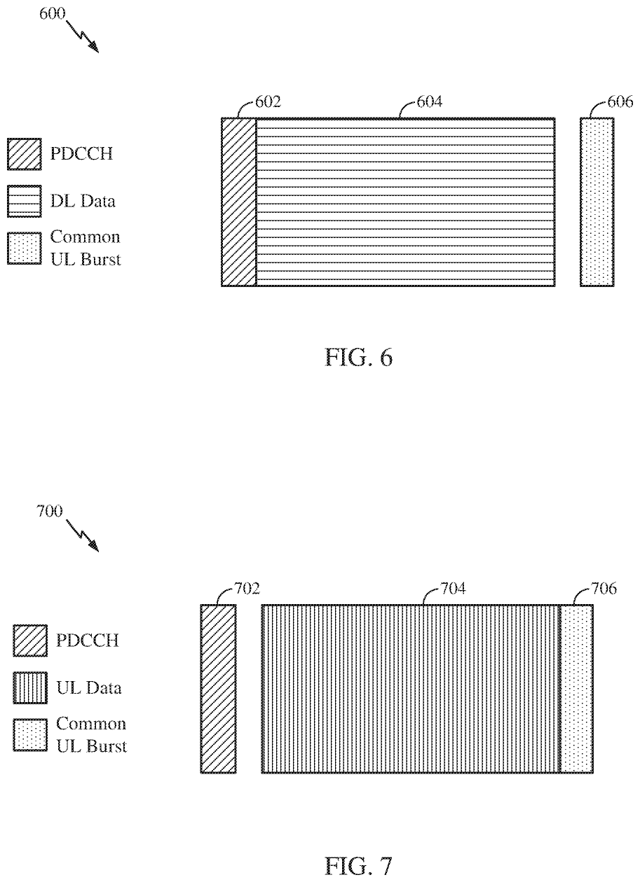

NR may utilize OFDM with a cyclic prefix (CP) on the uplink and downlink and include support for half-duplex operation using time division duplexing (TDD). A single component carrier (CC) bandwidth of 100 MHz may be supported. NR resource blocks may span 12 subcarriers with a subcarrier bandwidth of 75 kHz over a 0.1 ms duration. Each radio frame of 10 ms may consist of 2 half-frames of 5 ms, and each half-frame may consist of 5 subframes of 1 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such central units (CUs) and/or distributed units (DUs).

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs). In such examples, other UEs may utilize resources scheduled by the UE for wireless communication. In some examples, a UE may function as a scheduling entity in a peer-to-peer (P2P) network, and/or in a mesh network. In a mesh network example, UEs may optionally communicate directly with one another in addition to communicating with a scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As noted above, a Radio Access Network (RAN) may include a Central Unit (CU) and Distributed Units (DUs). A NR BS (e.g., gNB, 5G Node B, Node B, transmission reception point (TRP), access point (AP)) may correspond to one or multiple BSs. NR cells can be configured as access cell (ACells) or as data only cells (DCells). For example, the RAN (e.g., a CU or DU) can configure the cells. DCells may be cells used for carrier aggregation or dual connectivity, but not used for initial access, cell selection/reselection, or handover. In some cases DCells may not transmit synchronization signals (SS)—in some case cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

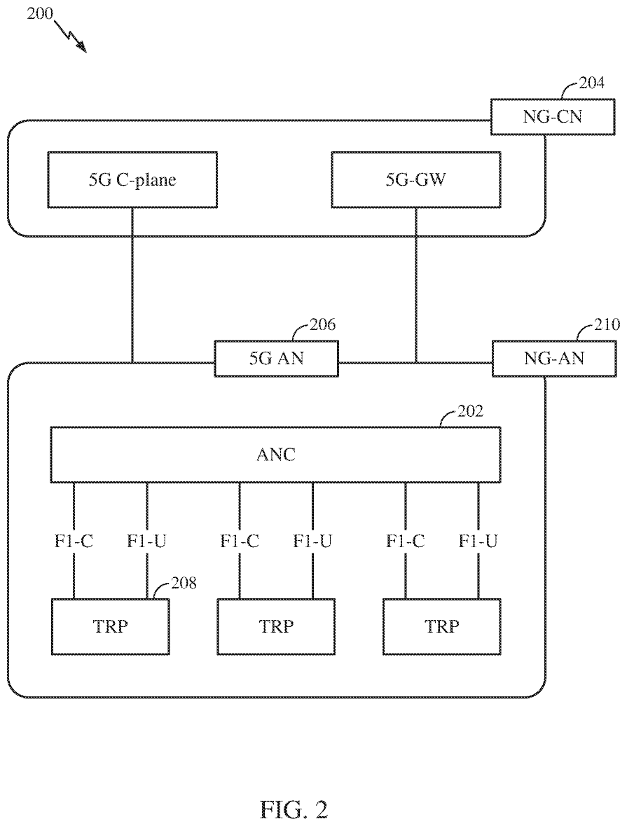

FIG. 2 illustrates an example logical architecture of a distributed Radio Access Network (RAN) 200, which may be implemented in the wireless communication system illustrated in FIG. 1. A 5G access node 206 may include an Access Node Controller (ANC) 202. The ANC may be a Central Unit (CU) of the distributed RAN 200. The backhaul interface to the Next Generation Core Network (NG-CN) 204 may terminate at the ANC. The backhaul interface to Neighboring Next Generation Access Nodes (NG-ANs) may terminate at the ANC. The ANC may include one or more TRPs 208 (which may also be referred to as BSs, NR BSs, Node Bs, 5G NBs, APs. or some other term). As described above, a TRP may be used interchangeably with “cell.”

The TRPs 208 may be a DU. The TRPs may be connected to one ANC (ANC 202) or more than one ANC (not illustrated). For example, for RAN sharing, radio as a service (RaaS), and service specific AND deployments, the TRP may be connected to more than one ANC. A Transmission Reception Point (TRP) may include one or more antenna ports. The TRPs may be configured to individually (e.g., dynamic selection) or jointly (e.g., joint transmission) serve traffic to a UE.

The logical architecture 200 may be used to illustrate fronthaul definition. The logical architecture 200 may support fronthauling solutions across different deployment types. For example, the logical architecture 200 may be based on transmit network capabilities (e.g., bandwidth, latency, and/or jitter).

The logical architecture 200 may share features and/or components with LTE. The Next Generation Access Node (NG-AN) 210 may support dual connectivity with NR. The NG-AN 210 may share a common fronthaul for LTE and NR.

The logical architecture 200 may enable cooperation between and among TRPs 208. For example, cooperation may be preset within a TRP and/or across TRPs via the ANC 202. There may be no inter-TRP interface.

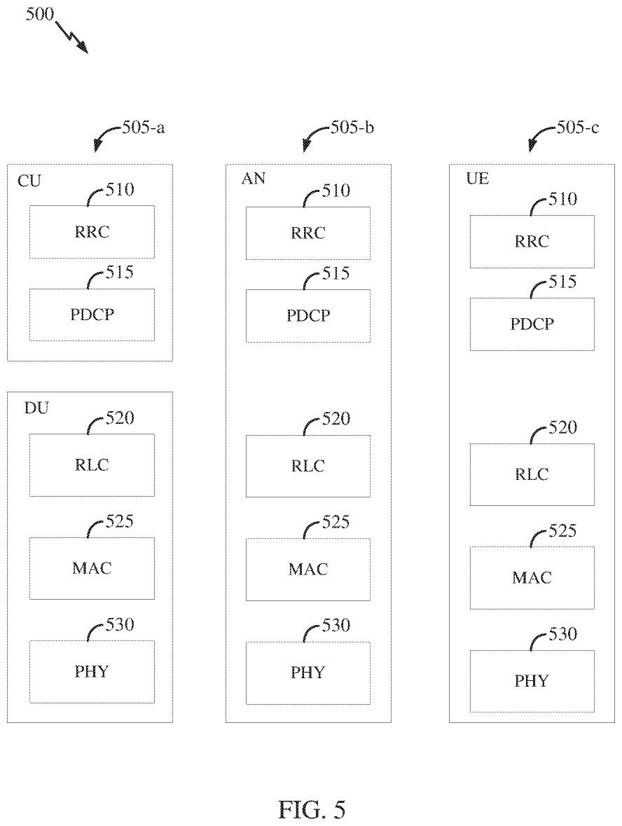

Logical architecture 200 may have a dynamic configuration of split logical functions. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively).

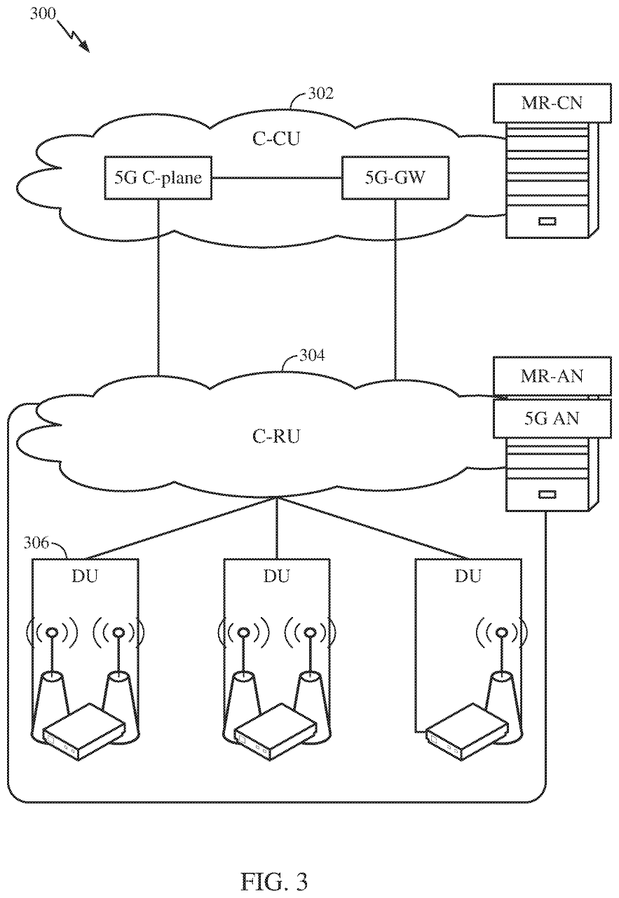

FIG. 3 illustrates an example physical architecture 300 of a distributed Radio Access Network (RAN), according to aspects of the present disclosure. A Centralized Core Network Unit (C-CU) 302 may host core network functions. The C-CU 302 may be centrally deployed. C-CU functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

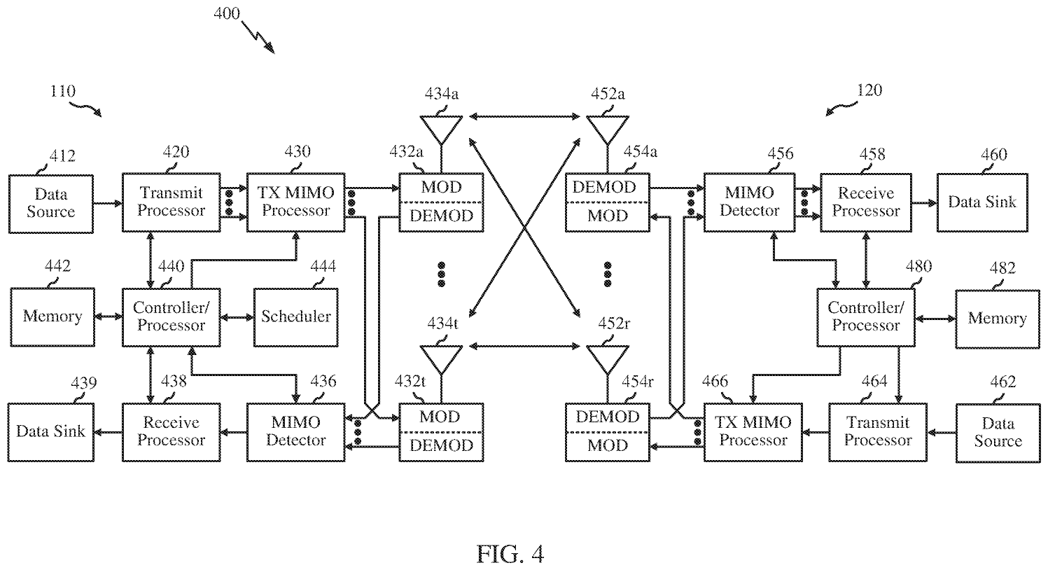

FIG. 4 shows a block diagram of a design of a BS 110 and a UE 120, which may be one of the BSs and one of the UEs in FIG. 1. For a restricted association scenario, the BS 110 may be the macro BS 110c in FIG. 1, and the UE 120 may be the UE 120y. The BS 110 may also be a BS of some other type. The BS 110 may be equipped with antennas 434a through 434t, and the UE 120 may be equipped with antennas 452a through 452r. The BS may include a TRP and may be referred to as a Master eNB (MeNB) (e.g., Master BS or Primary BS). The Master BS and the Secondary BS may be geographically co-located.

One or more components of the BS 110 and UE 120 may be used to practice aspects of the present disclosure. For example, antennas 452, transceivers 454, detector 456, processors 466, 458, 464, and/or controller/processor 480 of the UE 120 and/or antennas 434, transceivers 432, detector 436, processors 420, 430, 438, and/or controller/processor 440 of the BS 110 may be used to perform the various techniques and methods described herein.

At the BS 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH). Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the Primary Synchronization Signal (PSS), Secondary Synchronization Signal (SSS), and Cell-Specific Reference Signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) within transceivers 432a through 432t. Each modulator may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from transceivers 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from the demodulators in transceivers 454a through 454r, perform MIMO detection on the received symbols if applicable, and provide detected symbols. A receive processor 458 may process (e.g., deinterleave and decode) the detected symbols, provide decoded data for the UE 120 to a data sink 460, and provide decoded control information to a controller/processor 480.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the transceivers 432a through 432t, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. The processor 440 and/or other processors and modules at the BS 110 may perform or direct the execution of processes for the techniques described herein. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a wireless communication system, such as a 5G system. Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., an access node (AN), a new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

FIG. 6 is a diagram showing an example of a DL-centric subframe 600, such as may be used with a RAT like NR. The DL-centric subframe 600 may include a control portion 602. The control portion 602 may exist in the initial or beginning portion of the DL-centric subframe 600. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe 600 may also include a DL data portion 604. The DL data portion 604 may be referred to as the payload of the DL-centric subframe 600. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe 600 may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information. As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram showing an example of an UL-centric subframe 700. The UL-centric subframe 700 may include a control portion 702. The control portion 702 may exist in the initial or beginning portion of the UL-centric subframe. The control portion 702 in FIG. 7 may be similar to the control portion described above with reference to FIG. 6. The UL-centric subframe 700 may also include an UL data portion 704. The UL data portion 704 may sometimes be referred to as the payload of the UL-centric subframe 700. The UL portion may refer to the communication resources utilized to communicate UL data from the subordinate entity (e.g., UE) to the scheduling entity (e.g., UE or BS). In some configurations, the control portion 702 may be a physical UL control channel (PUCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe 700 may also include a common UL portion 706. The common UL portion 706 in FIG. 7 may be similar to the common UL portion 706 described above with reference to FIG. 7. The common UL portion 706 may additional or alternative include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services. UE-to-network relaying, vehicle-to-vehicle (V2V) communications, Internet of Everything (IoE) communications. IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Method of Modifying Channel State Information Reference Signals

A user equipment may receive reference signals on a downlink from a base station. For example, reference signals may include reference symbols that provide an amplitude and a phase reference for the user equipment to perform channel estimation and demodulation. As another example, the user equipment may use reference signals to measure received power (e.g., as a function of frequency) to calculate channel state information, such as channel quality indicators. Generally, such reference signals may be referred to as channel state information reference signals (CSI-RS).

Channel state information reference signals may be mapped to resource elements in resource blocks. The mapping may be dependent on, for example, the cyclic prefix in use, such as a normal cyclic prefix or an extended cyclic prefix. Further, the channel state information reference signals may be intentionally mapped to different resource element locations in a resource block. For example, the base station may allocate different resource element locations based on antenna ports so that while one antenna of the base station is transmitting a reference signal, the other antennas are not broadcasting reference signals. This mapping may reduce interference between reference signals. In some examples, a base station may allocate different numbers of resource elements to resource blocks based on the antenna port. For example, a base station may allocate relatively more resource elements per resource block to some antenna ports while it allocates relatively fewer resource elements per resource block to other antenna ports. For example, the number of resource elements allocated per resource block may be dependent on the relative speed of the user equipment as it moves within and between cells of a communication network.

Because a user equipment knows the content of the reference signals in advance, for example by storing in memory a table or database of all possible reference signals, it can compare reference signals received from a base station to the known reference signal and determine, for example, amplitude changes and phase shifts introduced by the air interface. The user equipment may subsequently use this channel state information to improve reception of other data on the air interface, e.g., by accounting for the amplitude changes and phase shifts when receiving subsequent transmission from the base station.

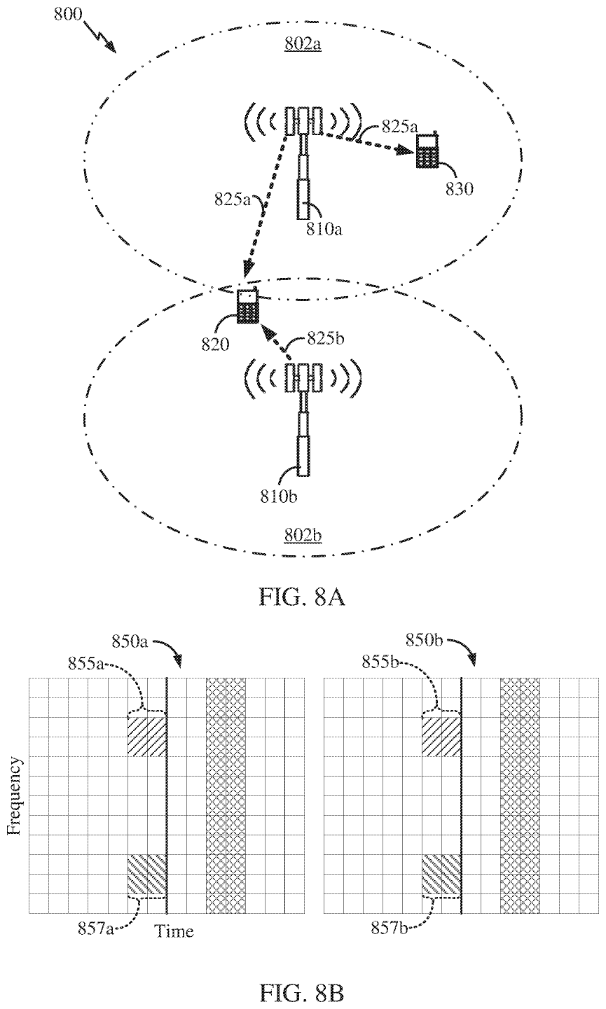

FIG. 8A depicts an example wireless communication system 800, including base stations 810a and 810b serving cells 802a and 802b, respectively. As depicted, user equipment 820 is located in an area of overlap between cells 802a and 802b where reference signals, such as channel state information reference signals (CSI-RS), are received by user equipment 820 from both base stations, 810a and 810b, on downlinks 825a and 825b, respectively. The simultaneous reception of channel state information reference signals by user equipment 820 may lead to interference between the reference signals received by user equipment 820. By contrast, user equipment 830 is only receiving channel state information reference signals from base station 810a on downlink 825a, without interference from base station 810b.

FIG. 8B depicts an example of resource element mappings for resource blocks 850a and 850b, which may be used by base stations 810a and 810b of FIG. 8A, respectively. The resource blocks 850a and 850b are depicted with frequency on the vertical axis, e.g., representing different subcarriers, and time on the horizontal axis, e.g., representing different symbols, such as OFDM reference symbols. Generally, as described above, a particular reference symbol may be mapped to a resource element by a frequency index (e.g., subcarrier), time index (e.g., OFDM symbol), and physical resource index (e.g., antenna port). In some examples the time index is a type of time parameter and the frequency index is a type of frequency parameter.

As depicted, resource block 850a includes a first block of four resource elements 855a, wherein each resource element in the block 855a is used for reference signals, such as channel state information reference signals. The resource elements 855a may include reference symbols for transmission on an air interface to a user equipment, such as user equipment 820 in FIG. 8A. Further, as discussed above, each of the four individual resource elements in resource element block 855a may be mapped to different antenna ports, such as four different antenna ports. Notably, this is merely one example, and other examples may have different numbers of resource elements allocated in each resource block, and those resource elements may be allocated to antenna ports in different ways.

Resource block 850a also includes a block of four resource elements 857a, which are also used for reference signals, such as channel state information reference signals. The resource elements in resource block 857a may be mapped to different antenna ports as compared to those of resource element block 855a.

Though not shown in FIG. 8B, a subsequent resource block for base station 810a may include resource elements dedicated to channel state information reference signals in the same configuration, but the reference symbols may be modified by the resource block ID.

Resource block 850b may be transmitted by a base station, such as base station 810b of FIG. 8A. Resource block 850b also includes blocks of resource elements 855b and 857b, which may be used for transmitting reference symbols from base station 810h, depicted in FIG. 8A. Notably, resource element blocks 855b and 857b of resource block 850b occupy the same frequency subcarriers and same symbol locations as those of 855a and 857a of resource block 850a. This is normally not an issue so long as the user equipment does not receive both these resource blocks from adjacent base stations at the same time. However, where a user equipment, such as user equipment 820a of FIG. 8A, is in range of adjacent base stations (such as 810a and 810b), detrimental interference in the reference signals is possible. For example, the interference may be greater because the randomness of the interference is reduced when the user equipment is receiving signals from multiple base stations at once.

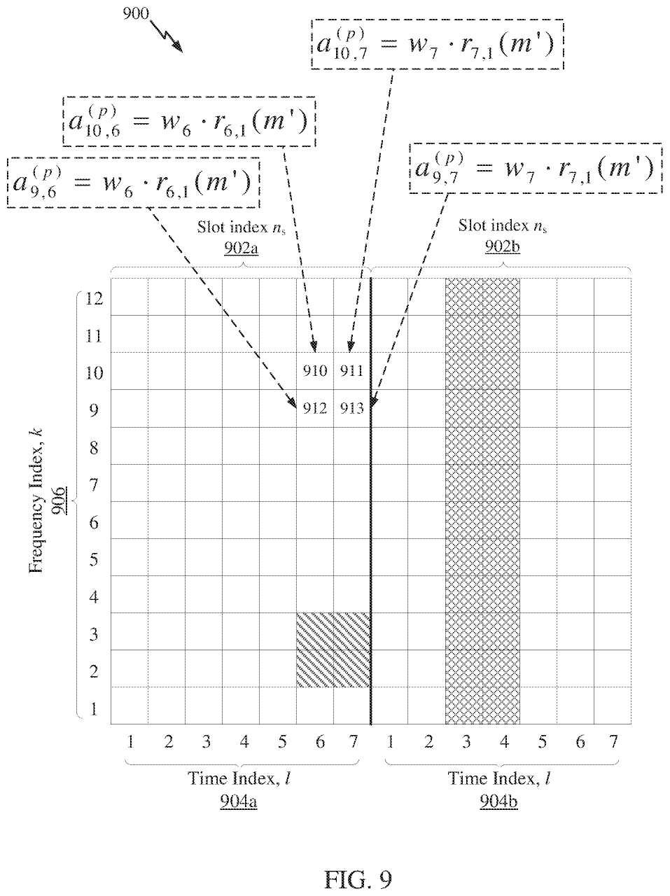

FIG. 9 depicts further details of an example of a resource block 900. For example, resource block 900 could correspond to one of the resource blocks 850a or 850b, described above with reference to FIG. 8B.

In the example depicted in FIG. 9, a plurality of a reference symbols (a_{k,l}^{(p)}) based on a plurality of pseudo-random sequences (r_{i,n}_{ₛ}(m′)) are mapped to a plurality of resource elements based on a resource block index m′, a slot index nₛ (e.g., 902a and 902b), a frequency-domain index k (e.g., 906), a time-domain index l (e.g., 904a and 904b), an antenna port index p, and an orthogonal cover code v. The transmitted reference signals can be written as:

a_{k,l}^{(p′)}=w_{l″}·r_{i,n}_{ₛ}(m′)

Where w={1 −1}, its value is based on the time location, frequency location of the CSI-RS and also dependent on the configured higher-layer parameter CDMType. Besides, k is a function of the resource block index m′ and the local subcarrier index k′ (=0, . . . , 11) within one resource block. From this equation, it is evident that for all the subcarriers in the same resource block, the reference signal is formed by the same sequence value, i.e., r_{l,n}_{ₛ}(m′).

In some examples, the pseudo-random sequences (r_{l,n}_{ₛ}(m′)) may be Gold sequences, which depend on parameters specific to the base station and/or the user equipment.

In FIG. 9, values of the reference symbols (a_{k,l}^{(p)}) mapped to resource elements 910-913 are shown in the superimposed boxes by way of example. Thus, resource element 910 derives its value from a pseudo-random sequence (r_{l,n}_{ₛ}(m′)) that is calculated using a time index value of 6 and a slot index value of 1 (which corresponds to slot 902a). Resource element 911 derives its value from a pseudo-random sequence that is calculated using a time index value of 7 and a slot index value of 1. Resource element 912 derives its value from a pseudo-random sequence that is calculated using a time index value of 6 and a slot index value of 1. Finally, resource element 913 derives its value from a pseudo-random sequence that is calculated using a time index value of 7 and a slot index value of 1.

Further, in this example, the reference symbols may be mapped to ports (p), such as ports 0-3, and transmitted with orthogonal cover codes. For example, resource blocks 910-913 maybe transmitted on port 0 with cover code {1, 1, 1, 1}, according to the following:

a_{10,6}⁽⁰⁾=r_{6,1}(m′) 910:

a_{10,7}⁽⁰⁾=r_{7,1}(m′) 911:

a_{9,6}⁽⁰⁾=r_{6,1}(m′) 912:

a_{9,7}⁽⁰⁾=r_{7,1}(m′) 913:

Similarly, resource blocks 910-913 maybe transmitted on port 1 with cover code {1, −1, 1, −1}, according to the following:

a_{10,6}⁽¹⁾=r_{6,1}(m′) 910:

a_{10,7}⁽¹⁾=−r_{7,1}(m′) 911:

a_{9,6}⁽¹⁾=r_{6,1}(m′) 912:

a_{9,7}⁽¹⁾=−r_{7,1}(m′) 913:

Further, resource blocks 910-913 maybe transmitted on port 2 with {1, −1, −1, 1}, according to the following:

a_{10,6}⁽²⁾=r_{6,1}(m′) 910:

a_{10,7}⁽²⁾=−r_{7,1}(m′) 911:

a_{9,6}⁽²⁾=−r_{6,1}(m′) 912:

a_{9,7}⁽²⁾=r_{7,1}(m′) 913:

And finally, resource blocks 910-913 maybe transmitted on port 3 with cover code {1, 1, −1, −1}, according to the following:

a_{10,6}⁽³⁾=r_{6,1}(m′) 910:

a_{10,7}⁽³⁾=r_{7,1}(m′) 911:

a_{9,6}⁽³⁾=−r_{6,1}(m′) 912:

a_{9,7}⁽³⁾=−r_{7,1}(m′) 913:

The preceding mappings of resource elements to specific ports using specific cover codes are merely one example and others are possible.

Though not shown in FIG. 9, in other examples, the pseudo-random reference sequences could also be based on the channel state information ID (CSI ID), a cyclic prefix type, among others. In cases where the reference signals are specific to a user equipment, the base station may precode the reference signals using antenna weights applied to other downlink signals. e.g., on the physical downlink shared channel (PDSCH). Further, user equipment-specific reference signal may only be transmitted in resource blocks used by the user equipment to avoid interference with other user equipment.

Notably, resource elements 910 and 912 have the same pseudo-random reference sequence value because the pseudo-random sequence for both resource elements 910 and 912 are based on the same time index (6) and same slot index (1). Similarly, resource elements 911 and 913 have the same pseudo-random reference sequence value because the pseudo-random reference sequence for both resource elements 911 and 913 are based on the same time index (7) and same slot index (1). In other words, there is no frequency-domain indexing of the pseudo-random sequences in the example described in FIG. 9.

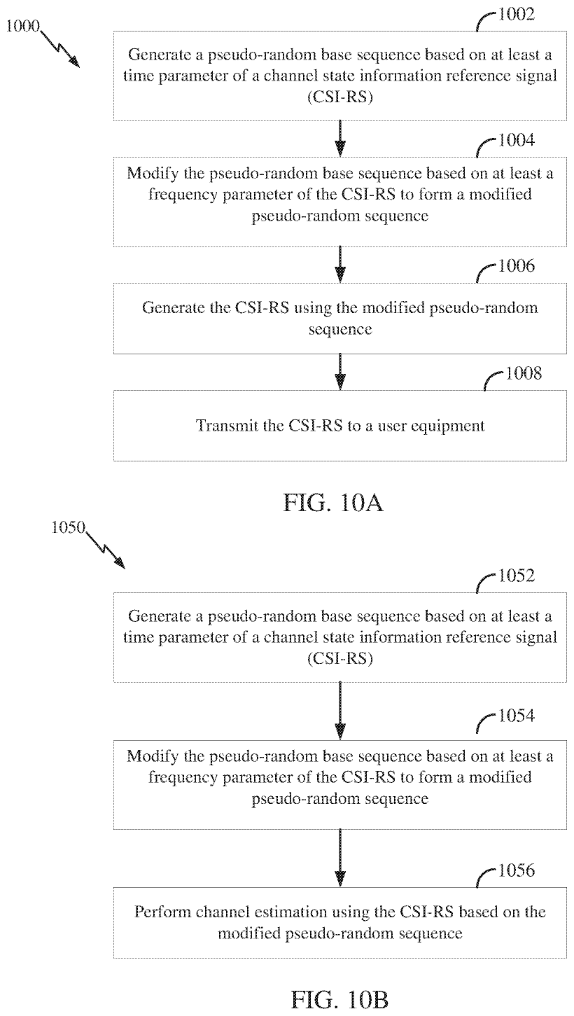

FIG. 10A depicts an example of a method 1000 for generating modified channel state information reference signals (CSI-RS). The method 1000 may be performed by a base stations, such as, for example, base stations 110a-c in FIG. 1 and base stations 810a-b in FIG. 8A. The method 1000 may beneficially decrease interference between reference signals being broadcast by adjacent base stations. For example, the method may improve the randomness of the pseudo-random reference signals by introducing a frequency-based index to the pseudo-random sequence generation.

The method begins at step 1002 where a pseudo-random base sequence is generated based on at least a time parameter, such as a CSI-RS time parameter. For example, the time parameter may be a symbol index and subframe or slot index of the CSI-RS.

In one example, the pseudo-random base sequence r_{i,n}_{ₛ}(m) is defined by

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {N}_{RB}^{max , DL} - 1$$

where nₛ is the slot number within a radio frame and l is the OFDM symbol number within the slot. Notably, in this example, the pseudo-random base sequence is indexed by slot number and OFDM symbol, which are both time-domain references.

In one example, the pseudo-random base sequence generator may be initialized with:

cᵢₙᵢₜ=2¹⁰·(7·(nₛ′+1)+l+1)·(2·N_{ID}^{CSI}+1)+2·N_{ID}^{CSI}+N_{CP}

at the start of each OFDM symbol, where:

$${n}_{s}^{′} = \{ \begin{matrix}10 ⌊ {n}_{s} / 10 ⌋ + {n}_{s} mod 2 & \begin{matrix}for frame structure type 3 \\ when the CSI \text{-} RS is part of a DRS\end{matrix} \\ {n}_{s} & otherwise\end{matrix} \\ {N}_{CP} = \{ \begin{matrix}1 & for normal CP \\ 0 & for extended CP\end{matrix}$$

N_{ID}^{CSI} equals N_{ID}^{cell} unless configured by higher layers.

In one example, the pseudo-random sequence c(i) may be defined by a length-31 Gold sequence. The output sequence c(n) of length M_{PN}, where n=0, 1, . . . . M_{PN}, is defined by:

c(n)=(x₁(n+N_{C})+x₂(n+N_{C}))mod 2

x₁(n+31)=(x₁(n+3)+x₁(n))mod 2

x₁(n+31)=(x₂(n+3)+x₂(n+2)+x₂(n+1)+x₁(n))mod 2

and where N_{C}=1600 and the first m-sequence shall be initialized with:

x₁(0)=1,x₁(n)=0,n=1,2, . . . ,30.

The initialization of the second m-sequence is denoted by:

cᵢₙᵢₜ=Σᵢ₌₀³⁰x₂(i)·2ⁱ

with the value depending on the application of the sequence.

The method 1000 then proceeds to step 1004 where the pseudo-random base sequence is modified based on at least a frequency parameter, such as a frequency parameter of the CSI-RS, to form a modified pseudo-random sequence. In some examples, the frequency parameter is a subcarrier index. The creation of a modified pseudo-random sequence is an improvement to the reference signal generation scheme described with respect to FIGS. 8A, 8B, and 9.

As a first example, the pseudo-random base sequence may be modified by generating a second pseudo-random sequence based at least in part on the subcarrier index and applying the second pseudo-random sequence, modified by a sequence of phase rotations, to the pseudo-random base sequence.

The second pseudo-random sequence could be another Gold sequence or an M-sequence or the like. The second pseudo-random sequence may be initialized with a seed that is based on a frequency index, such as frequency index 906 in FIG. 9. Further, the seed may be based on additional parameters, such as a physical cell identity (N_{ID}^{CSI}) and the downlink cyclic prefix length (N_{CP}), among others. For example, the second pseudo-random sequence generator may be initialized with:

cᵢₙᵢₜ=2⁴·k′·(2·N_{ID}^{CSI}+N_{CP})+k′

In the preceding equation, k′ denotes the subcarrier index within one resource block. Thereafter, the second pseudo-random sequence may be mapped to a sequence of random phase rotations. For example, the sequence of random phase rotations may be as such:

$${θ}_{{k}^{′}} ( i ) = \{ \begin{matrix}1 if {c}_{{k}^{′}} ( 2 i ) = 0 and {c}_{{k}^{′}} ( 2 i + 1 ) = 0 \\ - 1 if {c}_{{k}^{′}} ( 2 i ) = 0 and {c}_{{k}^{′}} ( 2 i + 1 ) = 1 \\ j if {c}_{{k}^{′}} ( 2 i ) = 1 and {c}_{{k}^{′}} ( 2 i + 1 ) = 0 \\ - j if {c}_{{k}^{′}} ( 2 i ) = 1 and {c}_{{k}^{′}} ( 2 i + 1 ) = 1\end{matrix}$$

In the preceding equations, i is an index of the element in the generated sequence. The modified pseudo-random sequence may then be formed by applying the second pseudo-random sequence, modified by the sequence of phase rotations, to the pseudo-random base sequence. For example, the modified pseudo-random sequence s_{l,n}_{ₛ}ₖ(m′) may be formed by an element-wise product of the pseudo-random base sequence and the second pseudo-random sequence, modified by the sequence of phase rotations:

s_{l,n}_{ₛ}_{k′}(i)=θ_{k′}(i)·r_{l,n}_{ₛ}(i)

Finally, the modified pseudo-random sequence may be mapped to resource elements in a resource block m′:

a_{k,l}^{(p)}=w_{l″}·s_{l,n}_{ₛ}_{,k′}(m′)

As a second example, the pseudo-random base sequence may be modified by permuting the pseudo-random base sequence via an interleaver. For example, where a pseudo-random base sequence initially includes elements in a particular sequence (e.g., {x1, x2, x3, x4}), a permutation (or interleaver) may be applied to randomly change the sequence of the elements (e.g., to {x4, x1, x3, x2}). Thus, a modified pseudo-random sequence is formed by permuting the pseudo-random base sequence via the interleaver.

In some examples, a set of interleavers are generated. The number of interleavers is equal to the number of possible values of the frequency index k′. In some cases, a particular interleaver is generated using the frequency index k′. In one example, a square interleaver with k′ rows works as follows. The sequence is input first across rows followed by across columns. The output sequence is firstly across columns then across rows. Furthermore, a set of helical interleaver can be applied. The helical interleaver is based on the square interleaver. Specifically, after inputting the sequence first across rows then columns, each column is cyclically shifted by a certain position. Then, the sequence is output firstly across the shifted columns and then across rows. By way of example, a second column denoted by {a, b, c, d}, may be shifted by one position resulting in {b, c, d, a}. A third column denoted by {x, y, z, q} may be shifted by two positions resulting in {z, q, x, y}. In the helical interleaver, the shift can be based on the frequency index k′. In particular, the sequence is firstly input into a square with M_{c} columns and Mᵣ rows, then the j-th column is shifted by (j−1)*k′ positions. So, for the k′-th interleaver generated using frequency index k′, the i-th element of the output sequence is equal to the i′-th element of the input sequence, where:

$$i = {i}_{mod {M}_{c}}^{′} \cdot {M}_{r} + {( ⌊ \frac{{i}^{′}}{{M}_{c}} + {i}_{mod {M}_{c}}^{′} \cdot {k}^{′} ⌋ )}_{mod {M}_{r}}$$

After having the set of interleavers, based on the frequency index k′, the associated interleaver is chosen to generate the modified sequence as follows:

s_{l,n}_{ₛ}_{k′}=π_{k′}(r_{l,n}_{ₛ})

Thereafter, the modified pseudo-random sequence may be mapped to a resource element in a resource block m′, according to:

a_{k,l}^{(p)}=w_{i″}·s_{l,n}_{ₛ}_{k′}(m′)

As a third example, the pseudo-random base sequence may be modified by selecting a segment of the pseudo-random base sequence to use as the modified pseudo-random sequence. For example, the pseudo-random base sequence may be truncated to form the modified pseudo-random sequence. This method is possible because in some examples the pseudo-random base sequence is much longer than the part that is used, e.g., as a signal reference. For example, the total length of the sequence may be 2\hat{ }31 if there are 100 resource blocks, but only 100 out of the 2\hat{ }31 elements are used, and the 100 elements used are determined based on the resource block index m′.

Notably, where there are two or more resource elements in one resource block, each resource block may use a distinct segment of the base sequence (r_{l,n}_{ₛ}).

For example, a segment of the pseudo-random base sequence may be used to form a modified pseudo-random sequence:

s_{l,n}_{ₛ}_{,k′}(m)=r_{l,n}_{ₛ}(m″)

where m″ is determined based at least in part on m′ and k′. For example, m″ may be determined according to the following:

m″=k′·N_{RB}^{MAX,DL}+m′,

where N_{RB}^{MAX,DL} is the maximum number of resource blocks in the downlink used for CSI-RS transmissions.

In some instances, other parameters may be used to calculate m″, such as: a physical layer cell identity (N_{ID}^{CSI}) and the downlink cyclic prefix length (NP), among others. For example, m″ may be calculated according to:

m″=2¹⁰·k′·N_{RB}^{MAX,DL}·(2·N_{ID}^{CSI}+1)+2¹⁰·N_{RB}^{MAX,DL}·(2·N_{ID}^{CSI}+N_{CP})+m′

Note that in some cases m″ may be longer that the length of the segment. In such cases, a wrap-around operation may be applied to m″ to conform the length of the segment.

After modifying the pseudo-random base sequence to form a modified pseudo-random sequence, the method 1000 proceeds to step 1006 where a channel state information reference signal (CSI-RS) is generated using the modified pseudo-random sequence.

Finally, the method proceeds to step 1008 where the channel state information reference signal (CSI-RS) (based on the modified pseudo-random sequence) is transmitted to a user equipment. For example, the CSI-RS (based on the modified pseudo-random sequence) may be transmitted to user equipment 820 from base station 110a via downlink 825a, as depicted with respect to FIG. 8A.

In other examples, method 1000 may include fewer or more steps and/or the order of the steps in method 1000 may be different as those discussed with reference to FIG. 10A.

A user equipment may generate the modified pseudo-random sequence in the same manner as the base station (e.g., using the same parameters as the base station). In some examples, the base station and user equipment may generate the modified pseudo-random sequences in accordance with a specification for a radio access technology, such as 4G, 5G, and the like. Thereafter, the user equipment may receive the modified pseudo-random sequence in the form of a channel state information reference signal (CSI-RS). The user equipment may then use the modified pseudo-random sequence to generate channel state information that is subsequently transmitted back to the base station to improve the quality of data transmissions between the user equipment and the base station.

FIG. 10B depicts an example of a method 1050 for performing channel estimation using channel state information reference signals (CSI-RS) based on modified pseudo-random sequences. For example, method 1050 may be performed by a user equipment, such as user equipments 120 in FIG. 1 or user equipments 820 and 830 in FIG. 8A.

The method 1050 begins at step 1052 where a pseudo-random base sequence is generated based on at least a time parameter, such as a channel state information reference signal (CSI-RS) time parameter. For example, the time parameter may be a symbol index and a subframe or slot index of the channel state information reference signal. In one example, the pseudo-random base sequence is generated as described above with respect to step 1002 of FIG. 10A.

The method 1050 then proceeds to step 1054 where the pseudo-random base sequence is modified based on at least a frequency parameter, such as a channel state information reference signal (CSI-RS) frequency parameter, to form a modified pseudo-random sequence. In some examples, the frequency parameter is a subcarrier index.

As a first example, the pseudo-random base sequence may be modified by generating a second pseudo-random sequence based at least in part on the subcarrier index and applying the second pseudo-random sequence, modified by a sequence of phase rotations, to the pseudo-random base sequence, as described above with respect to step 1004 of FIG. 10A.

As a second example, the pseudo-random base sequence may be modified by permuting the pseudo-random base sequence via an interleaver, as described above with respect to step 1004 of FIG. 10A.

As a third example, the pseudo-random base sequence may be modified by selecting a segment of the pseudo-random base sequence to use as the modified pseudo-random sequence, as described above with respect to step 1004 of FIG. 10A.

The method 1050 then proceeds to step 1056 where channel estimation is performed using a channel state information reference signal (CSI-RS) based on the modified pseudo-random sequence. For example, the modified pseudo-random sequence may be used to descramble a received channel state information reference signal, such as the CSI-RS generated at step 1006 and transmitted at step 1008 of FIG. 10A, and to perform channel estimation or measurement.

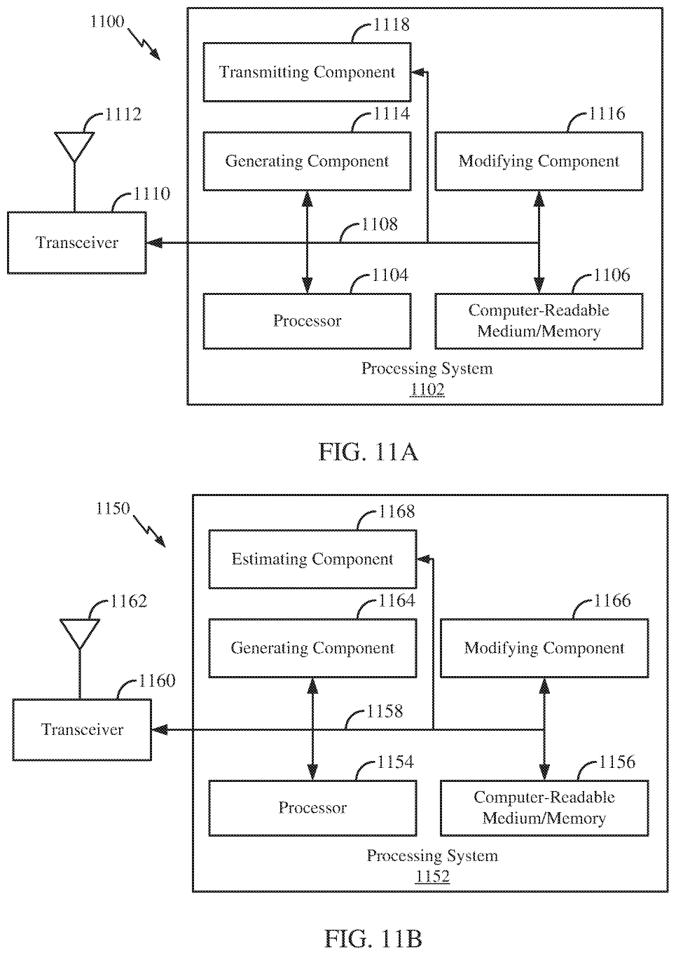

FIG. 11A depicts a communications device 1100 that may include various components (e.g., corresponding to means-plus-function components) configured to perform operations for the techniques disclosed herein, such as the operations illustrated in FIG. 10A. The communications device 1100 includes a processing system 1102 coupled to a transceiver 1110. The transceiver 1110 is configured to transmit and receive signals for the communications device 1100 via an antenna 1112, such as the various signal described herein. The processing system 1102 may be configured to perform processing functions for the communications device 1100, including processing signals received and/or to be transmitted by the communications device 1100. In some embodiments, communication device 1100 may be a base station, such as base stations 810a and 810b described with respect to FIG. 8A.

The processing system 1102 includes a processor 1104 coupled to a computer-readable medium/memory 1106 via a bus 1108. In certain aspects, the computer-readable medium/memory 1106 is configured to store computer-executable instructions that when executed by processor 1104, cause the processor 1104 to perform the operations illustrated in FIG. 10, or other operations for performing the various techniques discussed herein.

In certain aspects, the processing system 1102 further includes a generating component 1114 for performing the operations illustrated in FIG. 10A. Additionally, the processing system 1102 includes a modifying component 1116 for performing the operations illustrated in FIG. 10A. Additionally, the processing system 1102 includes a transmitting component 1118 for performing the operations illustrated in FIG. 10A. The generating 1114, modifying 1116, and transmitting component 1118 may be coupled to the processor 1104 via bus 1108. In certain aspects, the generating 1114, modifying 1116, and transmitting 1118 components may be hardware circuits. In certain aspects, the generating 1114, modifying 1116, and transmitting 1118 components may be software components that are executed and run on processor 1104.

FIG. 11B depicts a communications device 1150 that may include various components (e.g., corresponding to means-plus-function components) configured to perform operations for the techniques disclosed herein, such as the operations illustrated in FIG. 10B. The communications device 1150 includes a processing system 1152 coupled to a transceiver 1160. The transceiver 1160 is configured to transmit and receive signals for the communications device 1150 via an antenna 1162, such as the various signal described herein. The processing system 1152 may be configured to perform processing functions for the communications device 1150, including processing signals received and/or to be transmitted by the communications device 1150. In some embodiments, communication device 1150 may be a user equipment, such as user equipments 120 in FIG. 1 or user equipments 820 and 830 in FIG. 8A.

The processing system 1152 includes a processor 1154 coupled to a computer-readable medium/memory 1156 via a bus 1158. In certain aspects, the computer-readable medium/memory 1156 is configured to store computer-executable instructions that when executed by processor 1154, cause the processor 1154 to perform the operations illustrated in FIG. 10B, or other operations for performing the various techniques discussed herein.

In certain aspects, the processing system 1152 further includes a generating component 1164 for performing the operations illustrated in FIG. 10B. Additionally, the processing system 1152 includes a modifying component 1166 for performing the operations illustrated in FIG. 10B. Additionally, the processing system 1152 includes an estimating component 1168 for performing the operations illustrated in FIG. 10B. The generating 1164, modifying 1166, and estimating component 1168 may be coupled to the processor 1154 via bus 1158. In certain aspects, the generating 1164, modifying 1166, and estimating 1168 components may be hardware circuits. In certain aspects, the generating 1164, modifying 1166, and estimating 1168 components may be software components that are executed and run on processor 1154.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory). EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair. DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for perform the operations described herein and illustrated in FIG. 10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for generating a Channel State Information-Reference Signal (CSI-RS), comprising:
generating a pseudo-random base sequence based on at least a time parameter of the CSI-RS;
modifying the pseudo-random base sequence based on at least a frequency parameter of the CSI-RS to form a modified pseudo-random sequence;
generating the CSI-RS using the modified pseudo-random sequence; and
transmitting the CSI-RS to a user equipment.

2. The method of claim 1, wherein the time parameter comprises a symbol index and a slot index.

3. The method of claim 2, wherein the frequency parameter is a subcarrier index.

4. The method of claim 1, wherein modifying the pseudo-random base sequence comprises:
generating a second pseudo-random sequence based on a seed, wherein the seed is based on at least the frequency parameter; and
generating an element-wise product of the pseudo-random base sequence and the second pseudo-random sequence.

5. The method of claim 4,
wherein the modified pseudo-random sequence comprises a plurality of modified sequence elements, and
wherein each modified sequence element of the plurality of modified sequence elements is a product of a unique combination of a base sequence element of the pseudo-random base sequence and a second sequence element of the second pseudo-random sequence.

6. The method of claim 1, wherein modifying the pseudo-random base sequence comprises:
initializing an interleaver based on at least the subcarrier index; and
generating a permutation of the pseudo-random base sequence based on the interleaver.

7. The method of claim 1, wherein modifying the pseudo-random base sequence comprises: selecting a segment of the pseudo-random base sequence based on at least the subcarrier index.

8. The method of claim 1, wherein generating the pseudo-random base sequence is also based on a cyclic prefix.

9. The method of claim 1, wherein generating the pseudo-random base sequence is also based on a channel state information ID (CSI ID).

10. The method of claim 1, wherein generating the pseudo-random base sequence is also based on physical user equipment identity associated with the user equipment.

11. The method of claim 1, further comprising: pre-coding the CSI-RS using a pre-coding matrix indicator (PMI) associated with the user equipment.

12. An apparatus for generating a Channel State Information-Reference Signal (CSI-RS), comprising:
means for generating a pseudo-random base sequence based on at least a time parameter of the CSI-RS;
means for modifying the pseudo-random base sequence based on at least a frequency parameter of the CSI-RS to form a modified pseudo-random sequence;
means for generating the CSI-RS using the modified pseudo-random sequence; and
means for transmitting the CSI-RS to a user equipment.

13. The apparatus of claim 12, wherein the time parameter comprises a symbol index and a slot index.

14. The apparatus of claim 13, wherein the frequency parameter is a subcarrier index.

15. The apparatus of claim 12, wherein the means for modifying the pseudo-random base sequence is further configured for:
generating a second pseudo-random sequence based on a seed, wherein the seed is based on at least the frequency parameter; and
generating an element-wise product of the pseudo-random base sequence and the second pseudo-random sequence.

16. The apparatus of claim 15,
wherein the modified pseudo-random sequence comprises a plurality of modified sequence elements, and
wherein each modified sequence element of the plurality of modified sequence elements is a product of a unique combination of a base sequence element of the pseudo-random base sequence and a second sequence element of the second pseudo-random sequence.

17. The apparatus of claim 12, wherein the means for modifying the pseudo-random base sequence is further configured for:
initializing an interleaver based on at least the subcarrier index; and
generating a permutation of the pseudo-random base sequence based on the interleaver.

18. The apparatus of claim 12, wherein the means for modifying the pseudo-random base sequence is further configured for: selecting a segment of the pseudo-random base sequence based on at least the subcarrier index.

19. The apparatus of claim 12, wherein the means for generating the pseudo-random base sequence is configured to generate the pseudo-random base sequence further based on a cyclic prefix.

20. The apparatus of claim 12, wherein the means for generating the pseudo-random base sequence is configured to generate the pseudo-random base sequence further based on a channel state information ID (CSI ID).

21. The apparatus of claim 12, wherein the means for generating the pseudo-random base sequence is configured to generate the pseudo-random base sequence further based on a physical user equipment identity associated with the user equipment.

22. The apparatus of claim 12, wherein the means for transmitting the modified pseudo-random sequence is further configured for: pre-coding the CSI-RS using a pre-coding matrix indicator (PMI) associated with the user equipment.

23. A non-transitory computer readable medium comprising instructions that, when executed by a computing device, cause the computing device to perform a method for generating a Channel State Information-Reference Signal (CSI-RS), the method comprising:
generating a pseudo-random base sequence based on at least a time parameter of the CSI-RS;
modifying the pseudo-random base sequence based on at least a frequency parameter of the CSI-RS to form a modified pseudo-random sequence; and
generating the CSI-RS using the modified pseudo-random sequence; and
transmitting the CSI-RS to a user equipment.

24. The non-transitory computer readable medium of claim 23, wherein the time parameter comprises a symbol index and a slot index.

25. The non-transitory computer readable medium of claim 24, wherein the frequency parameter is a subcarrier index.

26. The non-transitory computer readable medium of claim 23, wherein modifying the pseudo-random base sequence comprises:
generating a second pseudo-random sequence based on a seed, wherein the seed is based on at least the frequency parameter; and
generating an element-wise product of the pseudo-random base sequence and the second pseudo-random sequence.

27. The non-transitory computer readable medium of claim 26,
wherein the modified pseudo-random sequence comprises a plurality of modified sequence elements, and
wherein each modified sequence element of the plurality of modified sequence elements is a product of a unique combination of a base sequence element of the pseudo-random base sequence and a second sequence element of the second pseudo-random sequence.

28. The non-transitory computer readable medium of claim 23, wherein modifying the pseudo-random base sequence comprises:
initializing an interleaver based on at least the subcarrier index; and
generating a permutation of the pseudo-random base sequence based on the interleaver.

29. The non-transitory computer readable medium of claim 23, wherein modifying the pseudo-random base sequence comprises: selecting a segment of the pseudo-random base sequence based on at least the subcarrier index.

30. The non-transitory computer readable medium of claim 23, wherein generating the pseudo-random base sequence is also based on a cyclic prefix.

31. The non-transitory computer readable medium of claim 23, wherein generating the pseudo-random base sequence is also based on a channel state information ID (CSI ID).

32. The non-transitory computer readable medium of claim 23, wherein generating the pseudo-random base sequence is also based on physical user equipment identity associated with the user equipment.

33. The non-transitory computer readable medium of claim 23, wherein the method further comprises: pre-coding the CSI-RS using a pre-coding matrix indicator (PMI) associated with the user equipment.

34. A method for performing channel estimation using a Channel State Information-Reference Signal (CSI-RS), comprising:
generating a pseudo-random base sequence based on at least a time parameter of the CSI-RS;
modifying the pseudo-random base sequence based on at least a frequency parameter of the CSI-RS to form a modified pseudo-random sequence; and
performing channel estimation using the CSI-RS based on the modified pseudo-random sequence.

35. The method of claim 34, wherein the time parameter comprises a symbol index and a slot index.

36. The method of claim 35, wherein the frequency parameter is a subcarrier index.

37. The method of claim 34, wherein modifying the pseudo-random base sequence comprises:
generating a second pseudo-random sequence based on a seed, wherein the seed is based on at least the frequency parameter; and
generating an element-wise product of the pseudo-random base sequence and the second pseudo-random sequence.

38. The method of claim 37,
wherein the modified pseudo-random sequence comprises a plurality of modified sequence elements, and
wherein each modified sequence element of the plurality of modified sequence elements is a product of a unique combination of a base sequence element of the pseudo-random base sequence and a second sequence element of the second pseudo-random sequence.

39. The method of claim 34, wherein modifying the pseudo-random base sequence comprises:
initializing an interleaver based on at least the subcarrier index; and
generating a permutation of the pseudo-random base sequence based on the interleaver.

40. The method of claim 34, wherein modifying the pseudo-random base sequence comprises: selecting a segment of the pseudo-random base sequence based on at least the subcarrier index.

41. The method of claim 34, wherein generating the pseudo-random base sequence is also based on a cyclic prefix.

42. The method of claim 34, wherein generating the pseudo-random base sequence is also based on a channel state information ID (CSI ID).

43. The method of claim 34, wherein generating the pseudo-random base sequence is also based on physical user equipment identity associated with the user equipment.

44. An apparatus for performing channel estimation using a Channel State Information-Reference Signal (CSI-RS), comprising:
means for generating a pseudo-random base sequence based on at least a time parameter of the CSI-RS;
means for modifying the pseudo-random base sequence based on at least a frequency parameter of the CSI-RS to form a modified pseudo-random sequence; and
means for performing channel estimation using the CSI-RS based on the modified pseudo-random sequence.

45. The apparatus of claim 44, wherein the time parameter comprises a symbol index and a slot index.

46. The apparatus of claim 45, wherein the frequency parameter is a subcarrier index.

47. The apparatus of claim 44, wherein the means for modifying the pseudo-random base sequence is further configured for:
generating a second pseudo-random sequence based on a seed, wherein the seed is based on at least the frequency parameter; and
generating an element-wise product of the pseudo-random base sequence and the second pseudo-random sequence.

48. The apparatus of claim 47,
wherein the modified pseudo-random sequence comprises a plurality of modified sequence elements, and
wherein each modified sequence element of the plurality of modified sequence elements is a product of a unique combination of a base sequence element of the pseudo-random base sequence and a second sequence element of the second pseudo-random sequence.

49. The apparatus of claim 44, wherein the means for modifying the pseudo-random base sequence is further configured for:
initializing an interleaver based on at least the subcarrier index; and
generating a permutation of the pseudo-random base sequence based on the interleaver.

50. The apparatus of claim 44, wherein the means for modifying the pseudo-random base sequence is further configured for: selecting a segment of the pseudo-random base sequence based on at least the subcarrier index.

51. The apparatus of claim 44, wherein the means for generating the pseudo-random base sequence is configured to generate the pseudo-random base sequence further based on a cyclic prefix.

52. The apparatus of claim 44, wherein the means for generating the pseudo-random base sequence is configured to generate the pseudo-random base sequence further based on a channel state information ID (CSI ID).

53. The apparatus of claim 44, wherein the means for generating the pseudo-random base sequence is configured to generate the pseudo-random base sequence further based on a physical user equipment identity associated with the user equipment.
